(19) United States
(12) Patent Application Publication
(10) Pub. No.: US 2025/0036005 A1
(43) Pub. Date: Jan. 30, 2025

(54) CONTROL DEVICE, QUANTUM ANNEALING SYSTEM, AND CONTROL METHOD

(71) Applicant: NEC Corporation, Tokyo (JP)

(72) Inventor: Yuki SUSA, Tokyo (JP)

(73) Assignee: NEC Corporation, Tokyo (JP)

(21) Appl. No.: 18/782,112

(22) Filed: Jul. 24, 2024

(30) Foreign Application Priority Data
Jul. 27, 2023 (JP) 2023-122734

(51) Int. Cl. G02F 1/39; G06N 10/40; H01S 3/108

(52) U.S. Cl. CPC G02F 1/39; G06N 10/40; H01S 3/1083

(57) ABSTRACT

A control device sets the value of a pump constant, which is a constant related to the initial value of a pump intensity of a quantum annealing device using Kerr nonlinear parametric oscillators, to a value determined based on the maximum number of interacting Kerr nonlinear parametric oscillators, an interaction intensity constant, which is a constant indicating the strength of the interaction of the Kerr nonlinear parametric oscillators, and a Kerr coefficient, which is a constant indicating the Kerr nonlinearity, or to a greater value; and controls the quantum annealing device based on the setting to cause quantum annealing to be performed.

This application is based upon and claims the benefit of priority from Japanese patent application No. 2023-122734, filed on Jul. 27, 2023, the disclosure of which is incorporated herein in its entirety by reference.

### TECHNICAL FIELD

The present disclosure relates to a control device, a quantum annealing system, and a control method.

### BACKGROUND ART

One device used in quantum computing is the Kerr nonlinear parametric oscillator (see, for example, Japanese Unexamined Patent Application Publication No. 2017-073106).

### SUMMARY

In quantum annealing with Kerr nonlinear parametric oscillators, it is desirable to obtain a solution even when three or more Kerr nonlinear parametric oscillators are interacting.

An example of an object of the present disclosure is to provide a control device, a quantum annealing system, a control method, and a program that can solve the above-mentioned problems.

According to the first example aspect of the disclosure, a control device controls a quantum annealing device provided with Kerr nonlinear parametric oscillators to perform quantum annealing, on the basis of an interaction number constant, which is a constant indicating the number of interacting Kerr nonlinear parametric oscillators and is set to three or a greater number, an interaction strength constant, which is a constant indicating the strength of interaction of the Kerr nonlinear parametric oscillators, a Kerr coefficient, which is a constant indicating the Kerr nonlinearity of the Kerr nonlinear parametric oscillators, and a pump constant, which is a constant related to the initial value of the pump intensity of the Kerr nonlinear parametric oscillators, which is set to a value determined by the interaction number constant, the interaction strength constant, and the Kerr coefficient, or to a greater value.

According to the second example aspect of the disclosure, a control device controls a quantum annealing device provided with Kerr nonlinear parametric oscillators to perform quantum annealing so as to, after starting to decrease a detuning value while keeping a pump intensity of the Kerr nonlinear parametric oscillators at 0, increase the pump intensity from 0.

According to the third example aspect of the disclosure, a quantum annealing system is provided with a quantum annealing device using Kerr nonlinear parametric oscillators and a control device, wherein the control device controls the quantum annealing device to perform quantum annealing, on the basis of an interaction number constant, which is a constant indicating the number of interacting Kerr nonlinear parametric oscillators and is set to three or a greater number; an interaction strength constant, which is a constant indicating the strength of interaction of the Kerr nonlinear parametric oscillators; a Kerr coefficient, which is a constant indicating the Kerr nonlinearity of the Kerr nonlinear parametric oscillators; and a pump constant, which is a constant related to the initial value of the pump intensity of the Kerr nonlinear parametric oscillators, which is set to a value determined by the interaction number constant, the interaction strength constant, and the Kerr coefficient, or to a greater value.

According to the fourth example aspect of the disclosure, a control method includes making a control device that controls a quantum annealing device using Kerr nonlinear parametric oscillators control the quantum annealing device to perform quantum annealing, on the basis of an interaction number constant, which is a constant indicating the number of interacting Kerr nonlinear parametric oscillators and is set to three or a greater number; an interaction strength constant, which is a constant indicating the strength of interaction of the Kerr nonlinear parametric oscillators; a Kerr coefficient, which is a constant indicating the Kerr nonlinearity of the Kerr nonlinear parametric oscillators; and a pump constant, which is a constant related to the initial value of the pump intensity of the Kerr nonlinear parametric oscillators, which is set to a value determined by the interaction number constant, the interaction strength constant, and the Kerr coefficient, or to a greater value.

According to the fifth example aspect of the disclosure, a control method includes making a control device that controls a quantum annealing device using Kerr nonlinear parametric oscillators control the quantum annealing device to perform quantum annealing so as to, after starting to decrease a detuning value while keeping a pump intensity at 0, increase the pump intensity from 0.

According to the sixth example aspect of the disclosure, a program is one for causing a computer that controls a quantum annealing device using Kerr nonlinear parametric oscillators to set the value of a pump constant, which is a constant related to the initial value of a pump intensity, of the quantum annealing device to a value determined based on the maximum number of interacting Kerr nonlinear parametric oscillators, an interaction intensity constant, which is a constant indicating the strength of the interaction of the Kerr nonlinear parametric oscillators, and a Kerr coefficient, which is a constant indicating Kerr nonlinearity, or to a greater value; and to control the quantum annealing device based on the settings to cause quantum annealing to be performed.

According to a seventh example aspect of the disclosure, a program is one for causing a computer that controls a quantum annealing device using Kerr nonlinear parametric oscillators to control the quantum annealing device to perform quantum annealing so as to, after starting to decrease a detuning value while keeping a pump intensity at 0, increase the pump intensity from 0.

### BRIEF DESCRIPTION OF THE DRAWINGS

FIG. 1 is a drawing showing an example of the configuration of a quantum annealing system according to the example embodiment.

FIG. 2 is a drawing showing an example of the configuration of a quantum annealing system according to the example embodiment.

FIG. 3 is a drawing showing an example of the configuration of a Kerr nonlinear parametric oscillator according to the example embodiment.

FIG. 4 is a drawing showing an example of the configuration of the control device according to the example embodiment.

FIG. 5 is a drawing showing an example of the value of αₘᵢₙ during the first-order phase transition in the example embodiment.

FIG. 6 is a drawing showing an example of the relationship between the value of α and the value of V(s) when a first-order phase transition occurs in the example embodiment.

FIG. 7 is a drawing showing a first example of the relationship between p and s_{c} in the example embodiment.

FIG. 8 is a drawing showing a first example of the relationship between p and α_{c} in the example embodiment.

FIG. 9 is a drawing showing a second example of the relationship between p and s_{c} in the example embodiment.

FIG. 10 is a drawing showing a second example of the relationship between p and α_{c} in the example embodiment.

FIG. 11 is a drawing showing an example of the value of αₘᵢₙ when the Hamiltonian shown in Expression (28) is used in the example embodiment.

FIG. 12 is a drawing showing an example of the procedure when the control device of the example embodiment controls the quantum annealing device to cause it to perform quantum annealing.

FIG. 13 is a drawing showing an example of the configuration of the control device according to the example embodiment.

FIG. 14 is a drawing showing an example of the configuration of the control device according to the example embodiment.

FIG. 15 is a drawing showing another example of the configuration of the quantum annealing system according to the example embodiment.

FIG. 16 is a drawing showing an example of the processing steps in the control method according to the example embodiment.

FIG. 17 is a drawing showing another example of the processing steps in the control method according to the example embodiment.

FIG. 18 is a schematic block diagram showing the configuration of a computer according to at least one example embodiment.

### EXAMPLE EMBODIMENT

The following is a description of example embodiments of the disclosure, but the following example embodiments shall not limit the disclosure as defined by the claims. Not all of the combinations of features described in the example embodiments are essential to the solution of the disclosure.

In the following, a letter marked with a circumflex may be indicated by prefixing the letter with a superscript “\hat{ }”. For example, “a” with a circumflex is denoted as a.

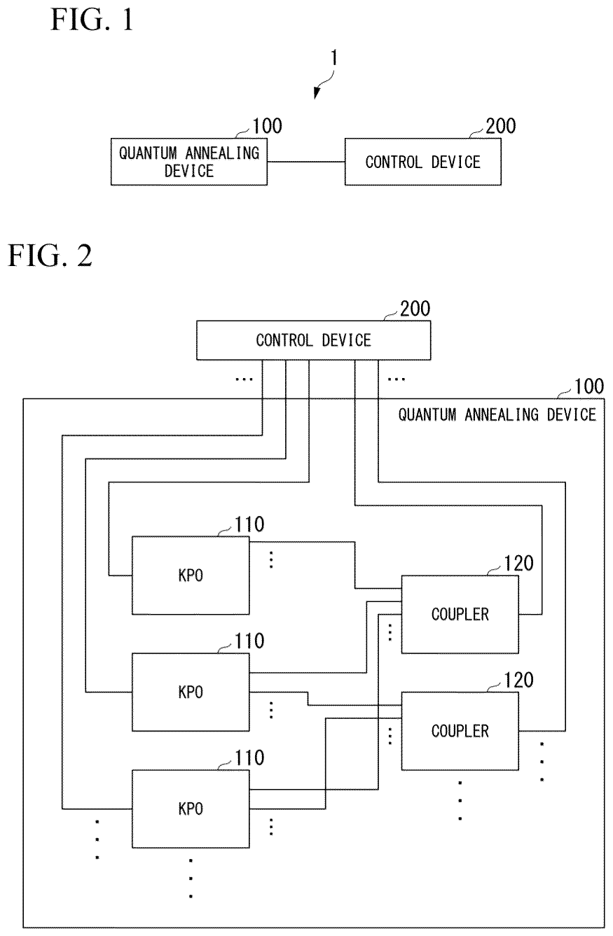

FIG. 1 is a drawing showing an example of the configuration of a quantum annealing system according to the example embodiment. In the configuration shown in FIG. 1, a quantum annealing system 1 is provided with a quantum annealing device 100 and a control device 200.

The quantum annealing system 1 is a system for performing quantum annealing. Specifically, the quantum annealing device 100 performs quantum annealing according to the control by the control device 200. Quantum annealing here is a method of finding a solution among solutions shown by the combination of quantum mechanical states, such that the value of the objective function that is set is minimized as much as possible. Alternatively, quantum annealing may be set up to find a solution such that the value of the objective function is as large as possible.

Quantum annealing can be viewed as a method of solving combinatorial optimization problems (also called discrete optimization problems) using quantum mechanical phenomena.

FIG. 2 is a drawing showing an example of the configuration of the quantum annealing device 100. In the configuration shown in FIG. 2, the quantum annealing device 100 is provided with a Kerr nonlinear parametric oscillator 110 and a coupler 120.

The Kerr nonlinear parametric oscillator 110 represents the variables in the target problem.

The Kerr nonlinear parametric oscillator 110 transitions its own state from an initial state, called the vacuum state, to one of two coherent states, according to the control of the control device 200. The two coherent states are mapped to values of binary variables, and the state transitions of the Kerr nonlinear parametric oscillator 110 can be viewed as a solution search.

The coupler 120 interacts with multiple Kerr nonlinear parametric oscillators 110. In the quantum annealing device 100, the coupler 120 facilitates interactions among the Kerr nonlinear parametric oscillators 110 such that any p out of N Kerr nonlinear parametric oscillators 110 interact with each other.

Here, N is an integer such that N≥1 and represents the number of Kerr nonlinear parametric oscillators 110 that the quantum annealing device 100 is equipped with.

p is a constant representing the number of Kerr nonlinear parametric oscillators 110 in one set of interacting Kerr nonlinear parametric oscillators 110, and is an integer such that p≥3. Assume that any combination of p Kerr nonlinear parametric oscillators 110 out of N Kerr nonlinear parametric oscillators 110 can interact. p is also referred to as the interaction number constant.

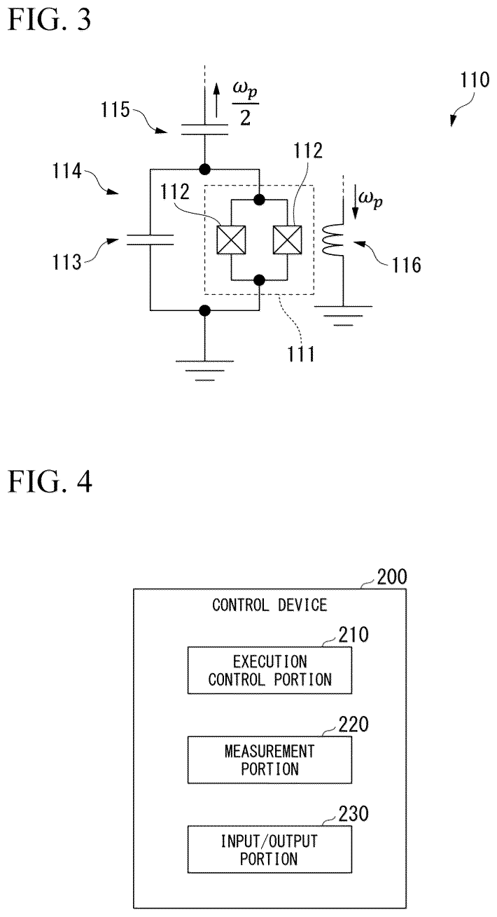

FIG. 3 is a drawing showing an example of the configuration of the Kerr nonlinear parametric oscillator 110. In the configuration shown in FIG. 3, the Kerr nonlinear parametric oscillator 110 is provided with a superconducting quantum interference device (SQUID) 111, capacitors 113 and 115, and a magnetic field generation portion 116. The superconducting quantum interference device 111 consists of a loop of superconductor with two Josephson junctions 112.

The magnetic field generation portion 116 is composed of a coil and generates a magnetic field in response to the current flowing through the magnetic field generation portion 116. The magnetic field generation portion 116 and the superconducting quantum interference device 111 are magnetically coupled, and magnetic flux is applied to the superconducting quantum interference device 111 when the magnetic field generation portion 116 generates a magnetic field.

The loop between the superconducting quantum interference device 111 and the capacitor 113 constitutes a resonant circuit 114. The resonant frequency of the resonant circuit 114 is controlled by the magnitude of the current flowing through the magnetic field generation portion 116. The inductance of the superconducting quantum interference device 111 periodically changes in response to periodic changes in the magnetic field produced by applying an alternating current to the magnetic field generation portion 116, and the resonant frequency of the resonant circuit 114 periodically changes. This periodic change in resonant frequency causes the resonant circuit 114 to parametrically resonate with changes in the magnetic field (AC magnetic field).

The fact that the magnetic field generation portion 116 generates a magnetic field can also be viewed as the magnetic field generation portion 116 outputting electromagnetic waves. The parametric resonance of the resonant circuit 114 to changes in the magnetic field can also be viewed as the resonant circuit 114 being parametrically resonant to the electromagnetic waves output by the magnetic field generation portion 116.

When the resonant frequency of the resonant circuit 114 is close to half the frequency of the current flowing through the magnetic field generation portion 116 and the magnitude of the current flowing through the magnetic field generation portion 116 is above a certain magnitude, parametric resonance causes the resonant circuit 114 to oscillate parametrically. The resonant circuit 114 oscillates at half the frequency of the current flowing through the magnetic field generation portion 116.

The current flowing through the magnetic field generation portion 116 (the current passed by the control device 200 to the magnetic field generation portion 116) is understood as the input signal to the Kerr nonlinear parametric oscillator 110 and is referred to as the pump signal. The frequency of the pump signal is the frequency of the current flowing through the magnetic field generation portion 116. The amplitude of the pump signal is the amplitude of the current flowing through the magnetic field generation portion 116.

The product β of the amplitude of the AC component of the pump signal current (current amplitude) i amperes (A) and the change in resonance frequency f due to the current value df/di, β=i*df/di, is called the pump signal intensity, or pump intensity. Here, “*” denotes multiplication.

Since the change in resonance frequency df/di with current value is determined by the structure and frequency of the circuit, the pump intensity β is proportional to the current amplitude of the pump signal. Therefore, the pump intensity can be adjusted by adjusting the current amplitude of the pump signal.

Increasing the value of pump intensity β is also referred to as strengthening the pump intensity or increasing the pump intensity.

The oscillation of the resonant circuit 114 is also referred to as the oscillation of the Kerr nonlinear parametric oscillator 110. If the angular frequency of the pump signal is ωₚ, the oscillation angular frequency of the Kerr nonlinear parametric oscillator 110 is ωₚ/2.

By observing that the Kerr nonlinear parametric oscillator 110 outputs an electromagnetic wave with a frequency half the frequency of the pump signal, it is confirmed that parametric oscillation is occurring.

The difference between the resonant frequency of the Kerr nonlinear parametric oscillator 110 minus the oscillation frequency is called the detuning. Let us denote the detuning by Δ. The detuning Δ is expressed as in Expression (1) using the resonance frequency ω₀ of the Kerr nonlinear parametric oscillator 110 and the oscillation angular frequency ωₚ/2.

$$Δ = {ω}_{0} - \frac{{ω}_{p}}{2} \qquad ( 1 )$$

The state of the resonant circuit 114 corresponds to the quantum state in the Kerr nonlinear parametric oscillator 110. The quantum state in the Kerr nonlinear parametric oscillator 110 is observed by measuring the phase of the electromagnetic waves output from the Kerr nonlinear parametric oscillator 110.

As mentioned above, the Kerr nonlinear parametric oscillator 110 transitions the quantum state in the Kerr nonlinear parametric oscillator 110 itself from an initial state, called the vacuum state, to one of two coherent states, according to the control of the control device 200.

FIG. 4 is a drawing showing an example of the configuration of the quantum annealing device 200. In the configuration shown in FIG. 4, the control device 200 is provided with an execution control portion 210, a measurement portion 220, and an input/output portion 230.

The execution control portion 210 controls the quantum annealing device 100 to perform quantum annealing. In particular, the execution control portion 210 controls the quantum annealing system on the basis of an interaction number constant p, the interaction strength constant J, the Kerr coefficient K, and the pump constant p.

The execution control portion 210 is an example of an execution control means.

As mentioned above, the interaction number constant p is an integer constant of p≥3, indicating the number of interacting Kerr nonlinear parametric oscillators 110.

The interaction strength constant J is a constant J>0 that indicates the strength of the interaction of the Kerr nonlinear parametric oscillators 110.

The Kerr coefficient K is a constant K>0 that indicates the Kerr nonlinearity of the Kerr nonlinear parametric oscillator 110.

The pump constant ξₚ is a constant related to the initial value of the pump intensity of the Kerr nonlinear parametric oscillator 110. The value of the pump constant ξₚ is set based on the value of the interaction number constant p, the value of the interaction strength constant J, and the value of the pump constant ξₚ.

The measurement portion 220 measures the state of the Kerr nonlinear parametric oscillator 110.

The input/output portion 230 inputs and outputs signals to and from the quantum annealing device 100. In particular, the input/output portion 230 outputs control parameter values for the Kerr nonlinear parametric oscillator 110 and the coupler 120. In this way, the control device 200 controls the quantum annealing device 100. The input/output portion 230 accepts the input of the oscillation signal of the Kerr nonlinear parametric oscillator 110. The measurement portion 220 measures the state of the Kerr nonlinear parametric oscillator 110 by measuring this oscillation signal. Specifically, as described above, the measurement portion 220 observes the quantum state in the Kerr nonlinear parametric oscillator 110 by measuring the phase of the electromagnetic wave output from the Kerr nonlinear parametric oscillator 110.

The control of the quantum annealing device 100 by the control device 200 shall be further described. An example of a case in which three or more Kerr nonlinear parametric oscillators 110 are interacting is when the Hamiltonian H(s) is expressed as in Expression (2).

$$H ( s ) = {\sum }_{i = 1}^{N} [ ( 1 - s ) Δ {\hat{a}}_{i}^{†} {\hat{a}}_{i} + \frac{K}{2} {\hat{a}}_{i}^{†2} {\hat{a}}_{i}^{2} - s \frac{{ξ}_{p}}{2} ( {\hat{a}}_{i}^{†2} + {\hat{a}}_{i}^{2} ) ] - \qquad ( 2 )$$

$${sJN [ \frac{1}{N} {\sum }_{i = 1}^{N} ( {\hat{a}}_{i}^{†} + {\hat{a}}_{i} ) ]}^{p}$$

s is a variable whose value monotonically increases from 0 to 1 over time.

The Hamiltonian is a function used as the objective function of quantum annealing. The quantum annealing system 1 transitions the state of the Kerr nonlinear parametric oscillator 110 so that the value of the Hamiltonian H(s) at each value of the variable s is as small as possible.

N is an integer N>0, representing the number of Kerr nonlinear parametric oscillators 110. Here, Δ is a constant to represent detuning, and Δ>0. (1−s)Δ represents the detuning, such that (1−s)Δ>0 when s=0 and (1−s)Δ=0 when s=1.

The \hat{ }aᵢ denotes the annihilation operator. The annihilation operator is also denoted as \hat{ }a_{ann_i}.

The \hat{ }aᵢ with the dagger symbol represents the creation operator. The creation operator is also denoted \hat{ }a_{cre_i}.

As mentioned above, the Kerr coefficient K is a constant indicating Kerr nonlinearity, where K>0.

As mentioned above, the pump constant ξₚ is a constant for representing the pump intensity, where ξₚ>0. The term s(ξₚ/2) represents the pump intensity, where s(ξₚ/2)=0 when s=0 and s(ξₚ/2)>0 when s=1.

As mentioned above, the interaction number constant p is a constant representing the number of Kerr nonlinear parametric oscillators 110 included in one set of interacting Kerr nonlinear parametric oscillators 110, and is an integer p≥3.

As mentioned above, the interaction strength constant J is a constant that represents the strength of the interaction between the Kerr nonlinear parametric oscillators 110. It is assumed that any combination of the p Kerr nonlinear parametric oscillators 110 interact with the same intensity.

Here, all quantum states generated by the Kerr nonlinear parametric oscillator 110 are approximated as the same coherent state. In other words, the quantum state can be approximated as in Expression (3).

$${{\vert Ψ ( s ) 〉 = {⊗}_{i = 1}^{N} \vert {α}_{i} 〉}_{i} = {⊗}_{i = 1}^{N} \vert α 〉}_{i} \qquad ( 3 )$$

An encircled x represents a tensor product. The tensor product is also denoted as ∘x.

The term “|Ψ(s)>” on the left-hand side of Expression (3) represents the quantum state of the entire quantum system, and it is shown that this quantum state depends on the parameter s.

The middle term “∘xᵢ₌₁^{N}|αᵢ>ᵢ” in Expression (3) indicates that the quantum state “|>ᵢ” exhibited by each of the Kerr nonlinear parametric oscillators 110 is a coherent state with amplitude αᵢ.

The term on the right-hand side of Expression (3), “∘xᵢ₌₁^{N}|α>ᵢ” indicates that the quantum state “|>ᵢ” exhibited by any Kerr nonlinear parametric oscillator 110 is a coherent state with the same amplitude α. Thus, Expression (3) represents the approximation that the quantum states of all Kerr nonlinear parametric oscillators 110 (all qubit values) are coherent states with the same amplitude α.

Here, with α as a real number, Expression (4) follows from the definition of a coherent state.

$${{{\hat{α}}_{i} \vert α 〉}_{i} = α \vert α 〉}_{i} \qquad ( 4 )$$

The “\hat{ }aᵢ” denotes an annihilation operator that acts only on the quantum state “|>ᵢ” of the i-th Kerr nonlinear parametric oscillator 110.

In Expression (4), the operation of applying the annihilation operator “\hat{ }aᵢ” to the coherent state “|α>i” of amplitude α, represented as “\hat{ }aᵢ|α>ᵢ”, is equivalent to “α|α>ᵢ”. This represents the definition of a coherent state.

For the Hamiltonian in Expression (2), the energy function (semiclassical approximate potential) V(s) in this quantum state is expressed as in Expression (5).

$$\begin{matrix}V ( s ) = {lim}_{N \to ∞} \frac{1}{N} 〈 Ψ ( s ) \vert \hat{H} ( s ) \vert Ψ ( s ) 〉 \\ = ( 1 - s ) Δ 〈 α \vert {\hat{a}}^{†} \hat{a} \vert α 〉 + \frac{K}{2} 〈 α \vert {\hat{a}}^{†2} {\hat{a}}^{2} \vert α 〉 - s \frac{{ξ}_{p}}{2} 〈 α \vert {\hat{a}}^{†2} {\hat{a}}^{2} \vert α 〉 - {sJ ( 〈 α \vert {\hat{a}}^{†} + \hat{a} \vert α 〉 )}^{p} \\ = ( 1 - s ) {Δα}^{2} + \frac{K}{2} {α}^{4} - s {ξ}_{p} {α}^{2} - {sJ ( 2 α )}^{p}\end{matrix} \qquad ( 5 )$$

The Hamiltonian “\hat{ }H(s)” of the entire quantum system, sandwiched between the quantum states “<Ψ(s)|” and “|Ψ(s)>”, represented as “<Ψ(s)|\hat{ }H(s)|Ψ(s)>”, represents the total energy of the entire quantum system. Here, the approximation is made that the quantum states of any Kerr nonlinear parametric oscillator 110 are coherent states of the same amplitude, allowing calculation of the approximate energy of the entire quantum system.

The first line of Expression (5), “(1/N)<Ψ(s)|\hat{ }H(s)|Ψ(s)>” represents the energy per Kerr nonlinear parametric oscillator 110. The limit of N→∞ represents the energy per Kerr nonlinear parametric oscillator 110 when there are an infinite number of Kerr nonlinear parametric oscillators, or a very large number.

The second and third lines of Expression (5), “(1−s)Δ<α|\hat{ }α_{cre_i}\hat{ }α|α>” and “(1−s)Δα²” represent the contribution of the detuning (1−s)Δ to the energy V(s). “(K/2)<α| \hat{ }α_{cre_i}²\hat{ }α²|α>” and “(K/2)α⁴” represent the contribution of the Kerr nonlinearity to the energy V(s) (the contribution of the Kerr coefficient K to the energy V(s)).

“s(ξₚ/2)<α|\hat{ }α_{cer_i}²\hat{ }α²|α>” and “sξₚα²” represent the contribution of the pump intensity s(ξₚ/2) to the energy V(s).

“sJ(<α|\hat{ }α_{cre_i}\hat{ }α|α>)^{p}” and “sJ(2α)^{p}” represent the contribution of the interaction of the Kerr nonlinear parametric oscillator 110 to the energy V(s), expressed using the interaction strength constant J.

The second to third lines of Expression (5) are calculated using Expression (4).

The value of α that minimizes the value of V(s) in Expression (5) is denoted as αₘᵢₙ. In other words, αₘᵢₙ is expressed as in Expression (6).

$${α}_{min} := {argmin}_{α} ( V ( s ) ) \qquad ( 6 )$$

argmin is a function that outputs the value of the argument that minimizes the value of the expression shown to its right.

By finding αₘᵢₙ at each value that variable s can take, it is possible to determine the ground state that each Kerr nonlinear parametric oscillator 110 can generate for each possible value of the variable s. For example, when s=0, V(s) takes the minimum value 0 when α=0. Accordingly, when s=0, αₘᵢₙ=0. At α=0, the state of the Kerr nonlinear parametric oscillator 110 is in its initial state, the vacuum state.

Regardless of the value of s, V(s)=0 when α=0.

If there is no non-zero value of α for which V(s)=0 holds any value of 0≤s≤1 then the state of the Kerr nonlinear parametric oscillator 110 will remain in a vacuum state while the value of s varies from 0 to 1 (i.e., from the beginning to the end of annealing) and it becomes impossible to perform a solution search.

Therefore, for the quantum annealing system 1 to be able to perform quantum annealing, when f(α):=V/α², the minimum value of f(α) must be less than or equal to 0 when 0≤s≤1.

Here, the α with the smallest value of f(α) is denoted as α_{c}. In other words, ac is expressed as in Expression (7).

$${α}_{c} := {argmin}_{α} f ( α ) \qquad ( 7 )$$

α_{c} satisfies Expression (8).

$$\frac{d f}{d α} {\vert}_{α = {α}_{c}} = K {α}_{c} - {2}^{p} s ( p - 2 ) J {α}_{c}^{p - 3} = 0 \qquad ( 8 )$$

Substituting this α_{c} into f(α) yields Expression (9).

$$g ( s ) := f ( {α}_{c} ) = ( 1 - s ) Δ + \frac{K}{2} {( \frac{K}{{2}^{p} ( p - 2 ) sJ} )}^{\frac{2}{p - 4}} - s {ξ}_{p} - {2}^{p} {sJ ( \frac{K}{{2}^{p} ( p - 2 ) sJ} )}^{\frac{p - 2}{p - 4}} \qquad ( 9 )$$

For the quantum annealing system 1 to be able to perform solution search by annealing, it is necessary for g(1)≤0. Therefore, it is necessary to adjust the value of each parameter so that g(1)≤0.

From Expression (9), Expression (10) is obtained as a necessary and sufficient condition for g(1)≤0.

$$\frac{K}{2} {( \frac{K}{{2}^{p} ( p - 2 ) sJ} )}^{\frac{2}{p - 4}} - {2}^{p} {J ( \frac{K}{{2}^{p} ( p - 2 ) J} )}^{\frac{p - 2}{p - 4}} \leq {ξ}_{p} \qquad ( 10 )$$

Expression (10) can be transformed as in Expression (11).

$$\frac{p - 4}{2 ( p - 2 )} {( \frac{{K}^{\frac{p - 2}{2}}}{{2}^{p} ( p - 2 ) J} )}^{\frac{2}{p - 4}} \leq {ξ}_{p} \qquad ( 11 )$$

In order for the quantum annealing system 1 to be able to perform solution search by annealing, the value of each parameter must be set so that Expression (11) is satisfied. Therefore, the execution control portion 210 controls the quantum annealing device 100 using the pump constant p that satisfies Expression (11) to cause quantum annealing to be performed.

Here, J is rewritten as in Expression (12) with the appropriate value of α as α₀.

$$J = \frac{{K}^{\frac{p - 2}{2}}}{{( 2 {α}_{0} )}^{p}} \qquad ( 12 )$$

Based on Expression (12), Expression (11) can be transformed as in Expression (13).

$$\frac{p - 4}{2 ( p - 2 )} {( \frac{{α}_{0}^{p}}{{2}^{p} ( p - 2 ) J} )}^{\frac{2}{p - 4}} \leq {ξ}_{p} \qquad ( 13 )$$

If Expression (13) is satisfied, there exists s such that 0<s≤1 and g(s)=0. Let s_{c} denote s at this time.

When s=s_{c}, the value of α at which V(s) is minimized changes discontinuously from α=0, where the state of the Kerr nonlinear parametric oscillator 110 is in the vacuum state, to α=α_{c}.

This change represents a first-order phase transition. In order for the quantum annealing system 1 to be able to perform quantum annealing based on the Hamiltonian shown in Expression (2) and to be able to perform solution search when p≥3, a first-order phase transition cannot be avoided.

When p=3, the value of s_{c} and the value of α_{c} when s=s_{c} can be obtained analytically.

If p=3, α_{c} is expressed as in Expression (14).

$${α}_{c} = \frac{{2}^{3} J}{K} s \qquad ( 14 )$$

Substituting α_{c} in Expression (14) for f(α) yields Expression (15).

$$g ( s ) := f ( {α}_{c} ) = ( 1 - s ) Δ + \frac{K}{2} {( \frac{{2}^{3} J}{K} s )}^{2} - s {ξ}_{p} - {2}^{3} sJ ( \frac{{2}^{3} J}{K} s ) \qquad ( 15 )$$

Finding s=s_{c}, where g(s)=0, leads to Expression (16).

$$g ( {s}_{c} ) = 0 \qquad ( 16 )$$

$$⇔ {2}^{5} {J}^{2} {s}_{c}^{2} + K ( Δ + {ξ}_{p} ) {s}_{c} - K Δ = 0$$

$$⇔ {s}_{c} = \frac{- K ( Δ + {ξ}_{p} ) + \sqrt{{{K}^{2} ( Δ + {ξ}_{p} )}^{2} + {2}^{7} {J}^{2} K Δ}}{{2}^{6} {J}^{2}} > 0$$

Based on Expression (12) with K=Δ=α₀=1 and ξₚ=1.5, s_{c}≈0.372, at which time α_{c}≈0.372.

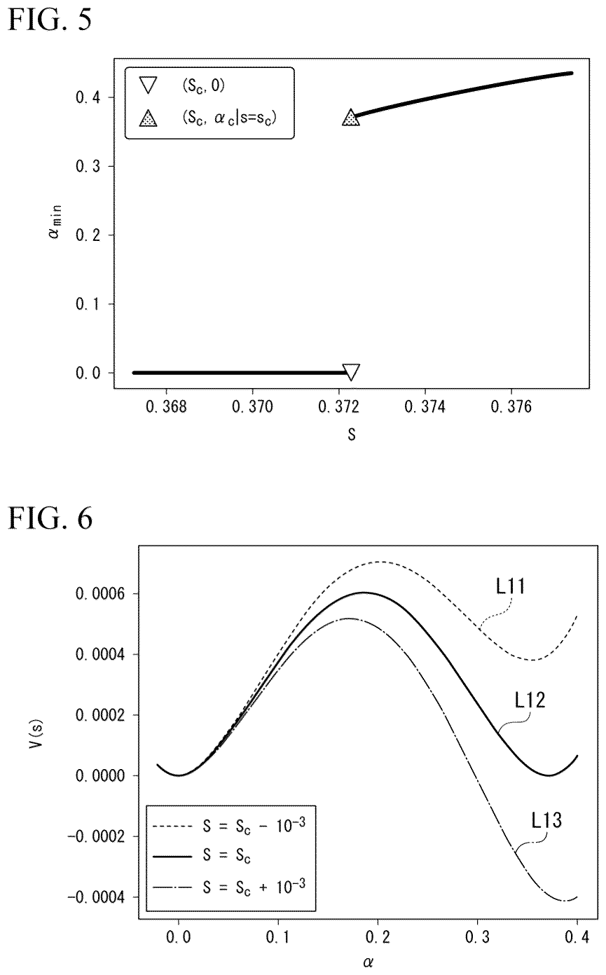

FIG. 5 shows an example of the value of αₘᵢₙ during the first-order phase transition. The horizontal axis of the graph in FIG. 5 shows the value of s. The vertical axis indicates the value of αₘᵢₙ.

FIG. 5 shows the numerical results obtained using minimize_scalar from SciPy to find the value of αₘᵢₙ that minimizes V(s) near s≈0.372. Around s_{c}≈0.372, the value of αₘᵢₙ undergoes a discontinuous change from 0 to α_{c}, indicating a first-order phase transition occurring here.

FIG. 6 shows an example of the relationship between the value of α and the value of V(s) when a first-order phase transition occurs. The horizontal axis of the graph in FIG. 6 shows the value of α. The vertical axis indicates the value of V(s).

Line L11 shows the relationship between the value of α and the value of V(s) when s=s_{c}−10⁻³ in the example in FIG. 5. Line L12 shows the relationship between the value of α and the value of V(s) when s=s_{c} in the example in FIG. 5. Line L13 shows the relationship between the value of α and the value of V(s) when s=s_{c}+10⁻³ in the example in FIG. 5.

In each of lines L11, L12, and L13, the value of V(s) is at a minimum at α=0.0, and there is also a minimum value of V(s) between α=0.3 and 0.4. This value of α between α=0.3 and 0.4 corresponds to α_{c} when the value of V(s) is at its minimum.

In the example in FIG. 6, there is a “mountain” between α=0 and α=α_{c}, where the value of V(s) is increasing. The change from α=0 to α=α_{c} through this “mountain” by the quantum mechanical tunneling effect causes a first-order phase transition.

For p≥5, it can be confirmed by numerical calculations that a first-order phase transition occurs. For the limit case where p approaches infinity (p→∞), the value of s_{c} and the value of α_{c} when s=s_{c} can be obtained analytically.

Based on Expression (12), the value of α_{c} when s=s_{c} is expressed as in Expression (17).

$${α}_{c} {\vert}_{s = {s}_{c}} = {( \frac{K}{{2}^{p} ( p - 2 ) {s}_{c} J} )}^{\frac{1}{p - 4}} = {( \frac{{α}_{0}^{p}}{( p - 2 ) {s}_{c} {K}^{\frac{p - 4}{2}}} )}^{\frac{1}{p - 4}} \qquad ( 17 )$$

Taking the log of both sides of Expression (17) yields Expression (18).

$$\begin{matrix}log {α}_{c} = \frac{1}{p - 4} ( p log {α}_{0} - log ( p - 2 ) - log {s}_{c} - \frac{p - 4}{2} log K ) \\ = \frac{1}{1 - \frac{4}{p}} log {α}_{0} - \frac{log ( p - 2 )}{p - 4} - \frac{log {s}_{c}}{p - 4} - \frac{1}{2} log K\end{matrix} \qquad ( 18 )$$

Taking the limit of p→∞ in Expression (18) yields Expression (19).

$${lim}_{p \to ∞} log {α}_{c} = log \frac{{α}_{0}}{\sqrt{K}} \qquad ( 19 )$$

From Expression (19), we obtain Expression (20).

$${lim}_{p \to ∞} {α}_{c} = \frac{{α}_{0}}{\sqrt{K}} \qquad ( 20 )$$

Substituting s=s_{c} in Expressions (12) and (15) leads to Expression (21).

$$g ( {s}_{c} ) := ( 1 - {s}_{c} ) Δ + \frac{K}{2} {( \frac{{α}_{0}}{{2}^{p} ( p - 2 ) {s}_{c} J} )}^{\frac{2}{p - 4}} - {s}_{c} {ξ}_{p} - {2}^{p} {s}_{c} J {( \frac{K}{{2}^{p} ( p - 2 ) {s}_{c} J} )}^{\frac{p - 2}{p - 4}} \qquad ( 21 )$$

Here, by taking the limit as p approaches infinity, we obtain Expression (22).

$${lim}_{p \to ∞} {( \frac{{α}_{0}}{{2}^{p} ( p - 2 ) {s}_{c} J} )}^{\frac{2}{p - 4}} = \frac{{α}_{0}^{2}}{K} \qquad ( 22 )$$

The “2^{p}_{S}_{_{c}}j(K/(2^{p}(p−2)s_{c}J)^{(p-2)(p-4)}” in Expression (21) can be transformed as in Expression (23).

$${2}^{p} {s}_{c} J {( \frac{K}{{2}^{p} ( p - 2 ) {s}_{c} J} )}^{\frac{p - 2}{p - 4}} = {2}^{p} {s}_{c} \frac{K \frac{p - 2}{2}}{{( 2 {α}_{0} )}^{p}} {( \frac{{α}_{0}^{p}}{( p - 2 ) {s}_{c} {K}^{\frac{p - 4}{2}}} )}^{\frac{p - 2}{p - 4}} = {( \frac{1}{p - 2} )}^{\frac{p - 2}{p - 4}} {α}_{0}^{\frac{2 p}{p - 4}} {s}_{c}^{\frac{- 2}{p - 4}} \qquad ( 23 )$$

Taking the limit as p approaches infinity in Expression (23), we obtain Expression (24).

$${lim}_{p \to ∞} {2}^{p} {s}_{c} {J ( \frac{K}{{2}^{p} ( p - 2 ) {s}_{c} J} )}^{\frac{p - 2}{p - 4}} = 0 \qquad ( 24 )$$

From Expressions (21), (22), and (24), we obtain Expression (25).

$${lim}_{p \to ∞} g ( {s}_{c} ) = ( 1 - {s}_{c} ) Δ + \frac{K}{2} \frac{{α}_{0}^{2}}{K} - {s}_{c} {ξ}_{p} \qquad ( 25 )$$

For the necessary and sufficient condition that the right-hand side “(1−s_{c})Δ+(K/2)(α₀²/K)−s_{c}ξₚ” of Expression (25) is zero, we obtain the condition as in Expression (26).

$$( 1 - {s}_{c} ) Δ + \frac{K}{2} \frac{{α}_{0}^{2}}{K} - {s}_{c} {ξ}_{p} = 0 ⇔ {s}_{c} = \frac{Δ + \frac{{α}_{0}^{2}}{2}}{Δ + {ξ}_{p}} \qquad ( 26 )$$

For example, if K=Δ=α₀=1 and ξₚ=1.5, then s_{c}→0.6 in the limit of p→∞, in which case α_{c}→1.

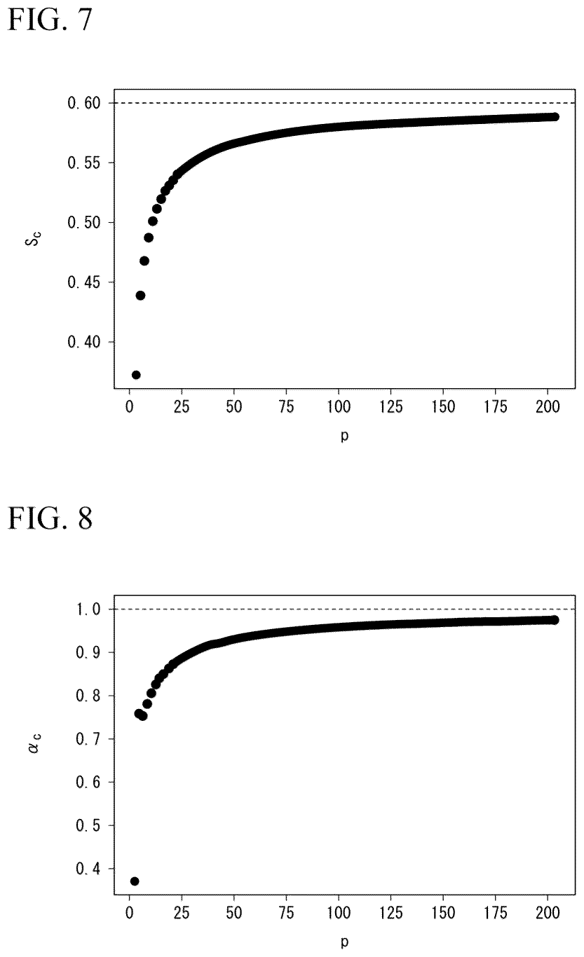

FIG. 7 shows a first example of the relationship between p and s_{c}. The horizontal axis of the graph in FIG. 7 shows the value of p. The vertical axis indicates the value of s_{c}.

FIG. 7 shows an example of the relationship between p and s_{c} when K=Δ=α₀=1 and ξₚ=1.5, with p→∞ and s_{c}→0.6.

FIG. 8 shows a first example of the relationship between p and α_{c}. The horizontal axis of the graph in FIG. 8 shows the value of p. The vertical axis indicates the value of α_{c}.

FIG. 8 shows an example of the relationship between p and α_{c} when K=Δ=α₀=1, ξₚ=1.5, and s=s_{c}, with p→∞ and α_{c}→0.8.

In the examples in FIGS. 7 and 8, as the value of p increases, the value of s_{c} and the value of α_{c} when s=s_{c} also increase, converging to the limit values of s_{c} and α_{c}, respectively. The value of α_{c} is positive when s=s_{c}, and a first-order phase transition has occurred.

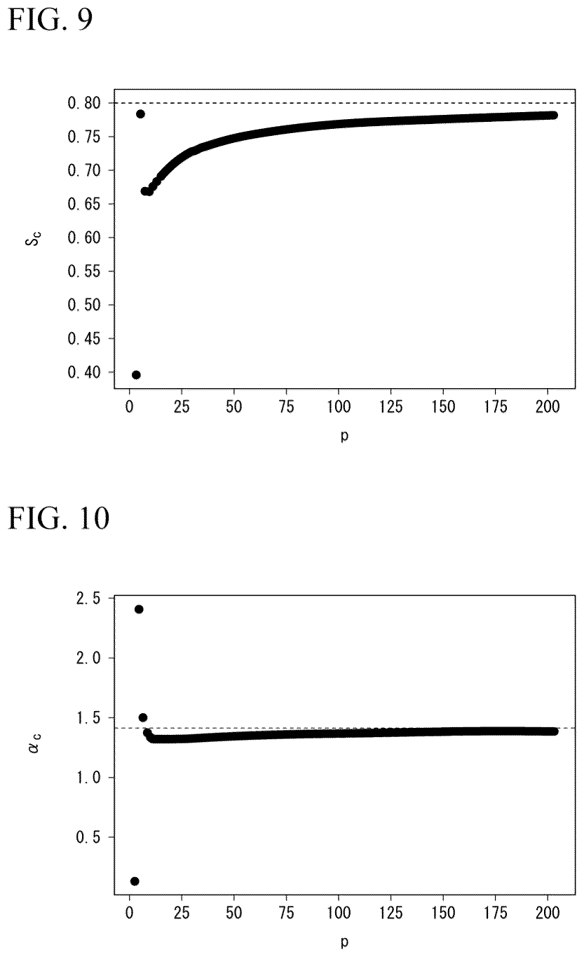

FIG. 9 shows a second example of the relationship between p and s_{c}. The horizontal axis of the graph in FIG. 9 shows the value of p. The vertical axis indicates the value of s_{c}.

FIG. 9 shows an example of the relationship between p and s_{c} when K=Δ=1, α₀=√2, and ξₚ=1.5, with p→∞ and s_{c}→0.8.

FIG. 10 shows a second example of the relationship between p and α_{c}. The horizontal axis of the graph in FIG. 10 shows the value of p. The vertical axis indicates the value of α_{c}.

FIG. 10 shows an example of the relationship between p and α_{c} when K=Δ=1, α₀=√2, ξₚ=1.5, and s=s_{c}, where p→∞ and α_{c}→√2.

In the examples in FIGS. 9 and 10, as the value of p increases, the value of s_{c} and the value of α_{c} when s=s_{c} also increase, converging to the limit values of s_{c} and α_{c}, respectively. The value of α_{c} is positive when s=s_{c}, and a first-order phase transition has occurred.

As shown above, if the Hamiltonian is shown as in Expression (2) and p≥3, a first-order phase transition must occur for the state of the Kerr nonlinear parametric oscillator 110 to change from a vacuum state to a coherent state so that a solution search can be performed.

On the other hand, if a first-order phase transition occurs, the time required for annealing increases exponentially with the number of Kerr nonlinear parametric oscillators 110 to wait for the tunneling effect to occur. From the viewpoint of reducing the time required for annealing as much as possible, it is preferable that the state of the Kerr nonlinear parametric oscillator 110 change from a vacuum state to a coherent state without a first-order phase transition occurring.

The change of the state of the Kerr nonlinear parametric oscillator 110 from a vacuum state to a coherent state without a first-order phase transition occurring is represented by a continuous change in αₘᵢₙ with respect to a change in s, and α_{c}=0 is required when s=s_{c}. To do so, the detuning should be zero when s=s_{c}.

Here, the Hamiltonian with ramp function is set so that the detuning is zero when s=s_{c}. The ramp function R(s) is shown in Expression (27).

$$R ( s ) = \{ \begin{matrix}s & ( s \geq 0 ) \\ 0 & ( s < 0 )\end{matrix} \qquad ( 27 )$$

It is also assumed that the variable s varies from −1 to 1, and that the execution of a single quantum annealing process (a single solution search) is started at s=−1 and is completed at s=1.

The quantum annealing system 1 performs quantum annealing using, for example, the Hamiltonian H(s) shown in Expression (28).

$$H ( s ) = {\sum }_{i = 1}^{N} [ R ( - s ) Δ {\hat{a}}_{i}^{†} {\hat{a}}_{i} + \frac{K}{2} {\hat{a}}_{i}^{†2} {\hat{a}}_{i}^{2} - R ( s ) \frac{{ξ}_{p}}{2} ( {\hat{a}}_{i}^{†2} + {\hat{a}}_{i}^{2} ) ] - R ( s ) {JN [ \frac{1}{N} {\sum }_{i = 1}^{N} ( {\hat{a}}_{i}^{†} + {\hat{a}}_{i} ) ]}^{p} \qquad ( 28 )$$

In Expression (28), R(−s)Δ represents the detuning. The value of R(−s)Δ decreases with the increase in the value of s while s increases from −1 to 0, and becomes R(−s)Δ=0 when s=0. As s increases from 0 to 1, R(−s)Δ=0.

In Expression (28), R(s)ξₚ/2 represents the pump intensity. While s increases from −1 to 0, R(s)ξₚ/2=0, and it remains R(s)ξₚ/2=0 when s=0. While s increases from 0 to 1, the value of R(s)ξₚ/2 increases with the increase in s.

Thus, in quantum annealing with the Hamiltonian H(s) shown in Expression (28), both the detuning and the pump intensity are zero when s=0.

The energy function (semiclassical approximation potential) V(s) under the approximation that the state of the Kerr nonlinear parametric oscillator 110 at s=0 is a coherent state is expressed as in Expression (29).

$$V ( s ) = R ( - s ) Δ {α}^{2} + \frac{K}{2} {α}^{4} - R ( s ) {ξ}_{p} {α}^{2} - R ( s ) {J ( 2 α )}^{p} \qquad ( 29 )$$

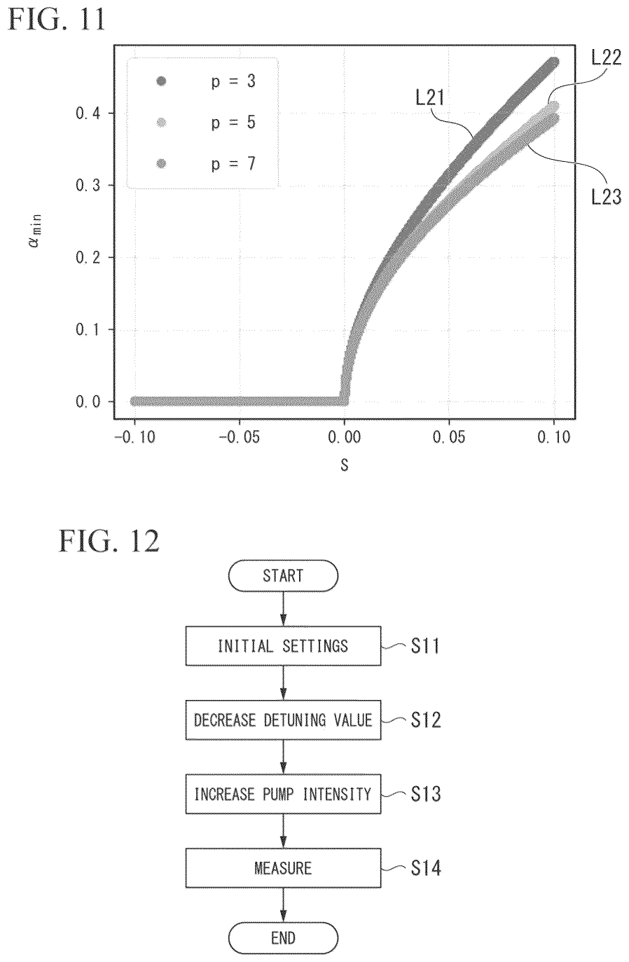

FIG. 11 shows an example of the value of αₘᵢₙ when the Hamiltonian H(s) shown in Expression (28) is used. The horizontal axis of the graph in FIG. 11 shows the value of s. The vertical axis indicates the value of αₘᵢₙ.

FIG. 11 shows the numerical results for the value of αₘᵢₙ, the α that minimizes the value of V(s), for each of p=3, 5, and 7, when J is expressed as in Expression (12), K=Δ=α₀=1 and p=1.5, in the vicinity of s=0. Line L21 shows the relationship between the value of s and the value of αₘᵢₙ for p=3. Line L22 shows the relationship between the value of s and the value of αₘᵢₙ for p=5. Line L23 shows the relationship between the value of s and the value of αₘᵢₙ for p=7.

The value of αₘᵢₙ varies continuously at s=0.

Alternatively, the execution control portion 210 may leave the pump intensity at 0 and begin decreasing the detuning value, then increase the pump intensity from 0 before the detuning value reaches 0. This is expected to result in a relatively small first-order phase transition and a relatively short time required for a single solution search in quantum annealing.

Expression (11) can also be approximated as in Expression (30).

$$\frac{1}{8} ( \frac{K}{{J}^{\frac{2}{p - 4}}} ) \leq {ξ}_{p} \qquad ( 30 )$$

The execution control portion 210 may control the quantum annealing device 100 to perform quantum annealing based on ξₚ, which is set to satisfy Expression (30).

Here, for large values of p, (p−4)/(p−2) in Expression (11) can be approximated by 1.

Also, (½^{p})^{2/(p-4)} in Expression (30) can be expressed as ½^{2p/(p-4)}. For large values of p, 2p/(p−4) can be approximated by 2, and (½p)^{2/(p-4)} can be approximated by ¼.

If the value of p is large, (1/(p−2))1/(p−4) can be approximated by 1. The exponent of K in Expression (11) is (p−2)/(p−4), which can be approximated by 1 for large values of p.

Thus, as above, Expression (11) can be approximated as in Expression (30).

FIG. 12 shows an example of the processing steps when the control device 200 controls the quantum annealing device 100 to perform quantum annealing.

In the process of FIG. 12, the execution control portion 210 performs the initial settings for control that causes the quantum annealing device 100 to perform quantum annealing, such as setting the value of the variable s to −1, for example (Step S11).

Next, the execution control portion 210 changes the detuning value according to the change in the value of variable s (Step S12).

After starting to change the detuning value, the execution control portion 210, which increases the pump intensity, may increase the pump intensity after the detuning value reaches zero. Alternatively, the execution control portion 210 may increase the pump intensity before the detuning value is zero.

After the time for one solution search in quantum annealing has elapsed, the measurement portion 220 measures the state of the Kerr nonlinear parametric oscillator (Step S14). In this way, the control device 200 obtains the solution of one solution search in quantum annealing.

After Step S14, the control device 200 terminates the process in FIG. 12.

As described above, the execution control portion 210 controls the quantum annealing device on the basis of an interaction number constant p, the interaction strength constant J, the Kerr coefficient K, and the pump constant ξₚ. The interaction number constant p is an integer constant representing the number of Kerr nonlinear parametric oscillators 110 interacting, with p≥3. The interaction strength constant J is a constant J>0 that indicates the strength of the interaction of the Kerr nonlinear parametric oscillators 110. The Kerr coefficient K is a constant K>0 that indicates the Kerr nonlinearity of the Kerr nonlinear parametric oscillator 110. The pump constant ξₚ is a constant related to the initial value of the pump intensity of the Kerr nonlinear parametric oscillator 110. The value of the pump constant ξₚ is set based on the value of the interaction number constant p, the value of the interaction strength constant J, and the value of the pump constant ξₚ.

According to the control device 200, even when three or more Kerr nonlinear parametric oscillators 110 are interacting, the state of the Kerr nonlinear parametric oscillator 110 can be transitioned from the vacuum state to a coherent state to obtain a solution in quantum annealing.

The value of the pump constant ξₚ is set to satisfy the above Expression (11) based on the interaction number constant p, the Kerr coefficient K, and the interaction strength constant J.

According to the control device 200, even when three or more Kerr nonlinear parametric oscillators 110 are interacting, the state of the Kerr nonlinear parametric oscillator 110 can be transitioned from the vacuum state to a coherent state to obtain a solution in quantum annealing.

The value of the pump constant ξₚ is set to satisfy the above Expression (30) based on the interaction number constant p, the Kerr coefficient K, and the interaction strength constant J.

According to the control device 200, even when three or more Kerr nonlinear parametric oscillators 110 are interacting, the state of the Kerr nonlinear parametric oscillator 110 can be transitioned from the vacuum state to a coherent state to obtain a solution in quantum annealing.

The execution control portion 210 also increases the pump intensity from 0 after starting to decrease the detuning value while keeping the pump intensity at 0.

According to the control device 200, by starting to decrease the detuning value before increasing the pump intensity, it is expected that a first-order phase transition in the state of each Kerr nonlinear parametric oscillator 110 will not occur, or that if it does, the magnitude of the first-order phase transition will be relatively small.

The execution control portion 210 also increases the pump intensity from 0 after setting the detuning value to 0. According to the control device 200, after setting the detuning value to 0, it is expected that increasing the pump intensity from 0 will cause a first-order phase transition in the state of each Kerr nonlinear parametric oscillator 110 to not occur.

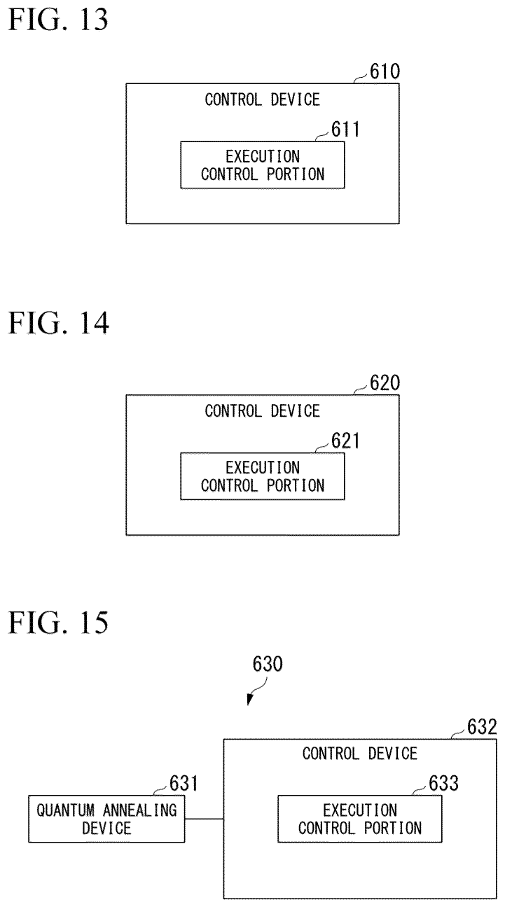

FIG. 13 shows another example of the configuration of the control device according to the example embodiment. In the configuration shown in FIG. 13, the control device 610 is provided with an execution control portion 611.

In such a configuration, the execution control portion 611 controls the quantum annealing device provided with Kerr nonlinear parametric oscillators to perform quantum annealing on the basis of an interaction number constant, which is a constant indicating the number of interacting Kerr nonlinear parametric oscillators and is set to three or a greater number, an interaction strength constant, which is a constant indicating the strength of interaction of the Kerr nonlinear parametric oscillators, a Kerr coefficient, which is a constant indicating the Kerr nonlinearity of the Kerr nonlinear parametric oscillator, and a pump constant, which is a constant related to the initial value of the pump intensity of the Kerr nonlinear parametric oscillator, which is set to a value determined by the interaction number constant, the interaction strength constant, and the Kerr coefficient, or to a greater value.

The execution control portion 611 is an example of an execution control means.

According to the control device 610, even when three or more Kerr nonlinear parametric oscillators are interacting, the state of the Kerr nonlinear parametric oscillator can be transitioned from the vacuum state to a coherent state to obtain a solution in quantum annealing.

FIG. 14 shows another example of the configuration of the control device according to the example embodiment. In the configuration shown in FIG. 14, the control device 620 is provided with an execution control portion 621.

In such a configuration, the execution control portion 621 controls the quantum annealing device provided with the Kerr nonlinear parametric oscillators to perform quantum annealing so as decrease the detuning value while keeping the pump intensity at 0, and then increasing the pump intensity from 0.

The execution control portion 621 is an example of an execution control means.

According to the control device 620, by starting to decrease the detuning value before increasing the pump intensity, it is expected that a first-order phase transition in the state of each Kerr nonlinear parametric oscillator will not occur, or that if it does, the magnitude of the first-order phase transition will be relatively small. This is expected to result in a relatively short time required for quantum annealing in the control device 620.

FIG. 15 is a drawing showing another example of the configuration of the quantum annealing system according to the example embodiment. In the configuration shown in FIG. 15, a quantum annealing system 630 is provided with a quantum annealing device 631 and a control device 632. The control device 632 is equipped with an execution control portion 633. In such a configuration, the execution control portion 633 controls the quantum annealing device provided with Kerr nonlinear parametric oscillators to perform quantum annealing on the basis of an interaction number constant, which is a constant indicating the number of interacting Kerr nonlinear parametric oscillators and is set to three or a greater number, an interaction strength constant, which is a constant indicating the strength of interaction of the Kerr nonlinear parametric oscillators, a Kerr coefficient, which is a constant indicating the Kerr nonlinearity of the Kerr nonlinear parametric oscillator, and a pump constant, which is a constant related to the initial value of the pump intensity of the Kerr nonlinear parametric oscillator, which is set to a value determined by the interaction number constant, the interaction strength constant, and the Kerr coefficient, or to a greater value.

The execution control portion 633 is an example of an execution control means.

According to the quantum annealing system 630, even when three or more Kerr nonlinear parametric oscillators are interacting, the state of the Kerr nonlinear parametric oscillator can be transitioned from the vacuum state to a coherent state to obtain a solution in quantum annealing.

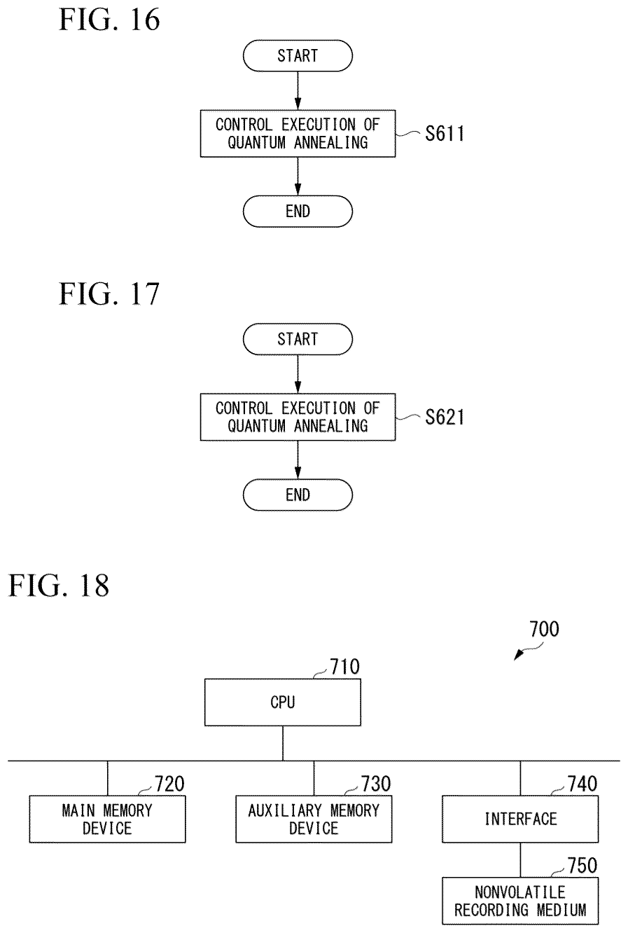

FIG. 16 is a drawing showing an example of the processing steps in the control method according to the example embodiment. The control method shown in FIG. 16 includes controlling the execution of quantum annealing (Step S611). In controlling the execution of quantum annealing (Step S611), the quantum annealing device is controlled to perform quantum annealing on the basis of an interaction number constant, which is a constant indicating the number of interacting Kerr nonlinear parametric oscillators and is set to three or a greater number, an interaction strength constant, which is a constant indicating the strength of interaction of the Kerr nonlinear parametric oscillators, a Kerr coefficient, which is a constant indicating the Kerr nonlinearity of the Kerr nonlinear parametric oscillator, and a pump constant, which is a constant related to the initial value of the pump intensity of the Kerr nonlinear parametric oscillator, which is set to a value determined by the interaction number constant, the interaction strength constant, and the Kerr coefficient, or to a greater value.

According to the control method shown in FIG. 16, even when three or more Kerr nonlinear parametric oscillators are interacting, the state of the Kerr nonlinear parametric oscillator can be transitioned from the vacuum state to a coherent state to obtain a solution in quantum annealing.

FIG. 17 is a drawing showing another example of the processing steps in the control method according to the example embodiment. The control method shown in FIG. 17 includes controlling the execution of quantum annealing (Step S621).

In controlling the execution of quantum annealing (Step S621), the control device that controls the quantum annealing device using the Kerr nonlinear parametric oscillators controls the quantum annealing device to perform annealing so as to start decreasing the detuning value with the pump intensity set to 0, and then increase the pump intensity from 0.

According to the control method shown in FIG. 17, by starting to decrease the detuning value before increasing the pump intensity, it is expected that a first-order phase transition in the state of each Kerr nonlinear parametric oscillator will not occur, or that if it does, the magnitude of the first-order phase transition will be relatively small. This is expected to result in a relatively short time required for quantum annealing in the control device 620.

FIG. 18 is a schematic block diagram showing the configuration of a computer according to at least one example embodiment.

In the configuration shown in FIG. 18, a computer 700 is provided with a CPU 710, a main memory device 720, an auxiliary memory device 730, an interface 740, and a nonvolatile recording medium 750.

Any one or more of the above control device 200, control device 610, and control device 620, or portions thereof, may be implemented in the computer 700. In that case, the operations of each of the above-mentioned processing portions are stored in the auxiliary memory device 730 in the form of a program. The CPU 710 reads the program from the auxiliary storage device 730, deploys it in the main memory device 720, and executes the above processing according to the program. The CPU 710 also reserves a memory area in the main memory device 720 corresponding to each of the above-mentioned memory portions, according to the program. Communication between each device and other devices is performed by the interface 740, which has a communication function and communicates according to the control of the CPU 710.

The interface 740 also has a port for the nonvolatile recording medium 750 and reads information from and writes information to the nonvolatile recording medium 750.

When the control device 200 is implemented in the computer 700, the operations of the execution control portion 210 and the measurement portion 220 are stored in the auxiliary storage device 730 in the form of programs. The CPU 710 reads the program from the auxiliary storage device 730, deploys it in the main memory device 720, and executes the above processing according to the program.

The CPU 710 also reserves a memory area in the main memory device 720 for processing by the control device 200 according to the program. The input/output of signals by the input/output portion 230 is performed by the interface 740, which inputs and outputs signals to and from other devices. Interaction between the control device 200 and the user is performed by the interface 740 having input and output devices, presenting information to the user with the output devices according to the control of the CPU 710 and accepting user operations with the input devices.

When the control device 610 is implemented in the computer 700, the operations of the execution control portion 611 are stored in the auxiliary storage device 730 in the form of a program. The CPU 710 reads the program from the auxiliary storage device 730, deploys it in the main memory device 720, and executes the above processing according to the program.

The CPU 710 also reserves a memory area in the main memory device 720 for processing by the control device 610 according to the program. The input and output of signals between the control portion 610 and other devices is performed by the interface 740, which inputs and outputs signals to and from other devices. Interaction between the control device 610 and the user is performed by the interface 740 having input and output devices, presenting information to the user with the output devices according to the control of the CPU 710 and accepting user operations with the input devices.

When the control device 620 is implemented in the computer 700, the operations of the execution control portion 611 are stored in the auxiliary storage device 730 in the form of a program. The CPU 710 reads the program from the auxiliary storage device 730, deploys it in the main memory device 720, and executes the above processing according to the program.

The CPU 710 also reserves a memory area in the main memory device 720 for processing by the control device 620 according to the program. The input and output of signals between the control portion 620 and other devices is performed by the interface 740, which inputs and outputs signals to and from other devices. Interaction between the control device 620 and the user is performed by the interface 740 having input and output devices, presenting information to the user with the output devices according to the control of the CPU 710 and accepting user operations with the input devices.

Any one or more of the above programs may be recorded on the nonvolatile recording medium 750. In this case, the interface 740 may read the program from the nonvolatile recording medium 750. The CPU 710 may then directly execute the program read by the interface 740, or it may be stored once in the main memory device 720 the or auxiliary memory device 730 and then executed.

A program for executing all or part of the processing performed by the control device 200, the control device 610, and the control device 620 may be recorded on a computer-readable recording medium, and the computer system may read and execute the program recorded on this recording medium to perform the processing of each part. The term “computer system” here shall include an operating system (OS) and hardware such as peripheral devices.

In addition, “computer-readable recording medium” means a portable medium such as a flexible disk, magneto-optical disk, ROM (Read Only Memory), CD-ROM (Compact Disc Read Only Memory), or other storage device such as a hard disk built into a computer system. The above program may be used to realize some of the aforementioned functions, and may also be used to realize the aforementioned functions in combination with programs already recorded in the computer system.

While preferred example embodiments of the disclosure have been described and illustrated above, it should be understood that these are exemplary of the disclosure and are not to be considered as limiting. Additions, omissions, substitutions, and other modifications can be made without departing from the scope of the present disclosure. Accordingly, the disclosure is not to be considered as being limited by the foregoing description, and is only limited by the scope of the appended claims.

Some or all of the above example embodiments may also be described as, but not limited to, the following supplementary notes.

### (Supplementary Note 1)

A control device provided with an execution control means for controlling a quantum annealing device provided with Kerr nonlinear parametric oscillators to perform quantum annealing, on the basis of an interaction number constant, which is a constant indicating the number of interacting Kerr nonlinear parametric oscillators and is set to three or a greater number; an interaction strength constant, which is a constant indicating the strength of interaction of the Kerr nonlinear parametric oscillators; a Kerr coefficient, which is a constant indicating the Kerr nonlinearity of the Kerr nonlinear parametric oscillators; and a pump constant, which is a constant related to the initial value of the pump intensity of the Kerr nonlinear parametric oscillators, which is set to a value determined by the interaction number constant, the interaction strength constant, and the Kerr coefficient, or to a greater value.

### (Supplementary Note 2)

The control device according to Supplementary Note 1, wherein the value of the pump constant is set to the value of

$$\frac{p - 4}{2 ( p - 2 )} {( \frac{{K}^{\frac{p - 2}{2}}}{{2}^{p} {( p - 2 )}^{J}} )}^{\frac{2}{p - 4}}$$

or a value greater than that based on the interaction number constant p, the Kerr coefficient K, and the interaction strength constant J.

### (Supplementary Note 3)

The control device according to Supplementary Note 1, wherein the value of the pump constant is set to the value of

$$\frac{1}{8} ( \frac{K}{{J}^{\frac{2}{p - 4}}} )$$

or a value greater than that based on the Kerr coefficient K, the interaction strength constant J, and the maximum value p of the number of interacting Kerr nonlinear parametric oscillators.

### (Supplementary Note 4)

The control device according to any one of supplementary notes 1 to 3, wherein the execution control means, after starting to decrease a detuning value while keeping a pump intensity at 0, increases the pump intensity from 0.

### (Supplementary Note 5)

The control device according to Supplementary Note 4, wherein the execution control means, after setting the detuning value to 0, increases the pump intensity from 0.

### (Supplementary Note 6)

A control device provided with an execution control means for controlling a quantum annealing device provided with Kerr nonlinear parametric oscillators to perform quantum annealing so as to, after starting to decrease a detuning value while keeping a pump intensity of the Kerr nonlinear parametric oscillators at 0, increase the pump intensity from 0.

### (Supplementary Note 7)

A quantum annealing system provided with a quantum annealing device using Kerr nonlinear parametric oscillators and a control device,

wherein the control device is provided with an execution control means for controlling a quantum annealing device to perform quantum annealing, on the basis of an interaction number constant, which is a constant indicating the number of interacting Kerr nonlinear parametric oscillators and is set to three or a greater number; an interaction strength constant, which is a constant indicating the strength of interaction of the Kerr nonlinear parametric oscillators; a Kerr coefficient, which is a constant indicating the Kerr nonlinearity of the Kerr nonlinear parametric oscillators; and a pump constant, which is a constant related to the initial value of the pump intensity of the Kerr nonlinear parametric oscillators, which is set to a value determined by the interaction number constant, the interaction strength constant, and the Kerr coefficient, or to a greater value.

### (Supplementary Note 8)

A control method wherein a control device that controls a quantum annealing device using Kerr nonlinear parametric oscillators is made to

control the quantum annealing device to perform quantum annealing, on the basis of an interaction number constant, which is a constant indicating the number of interacting Kerr nonlinear parametric oscillators and is set to three or a greater number; an interaction strength constant, which is a constant indicating the strength of interaction of the Kerr nonlinear parametric oscillators; a Kerr coefficient, which is a constant indicating the Kerr nonlinearity of the Kerr nonlinear parametric oscillators; and a pump constant, which is a constant related to the initial value of the pump intensity of the Kerr nonlinear parametric oscillators, which is set to a value determined by the interaction number constant, the interaction strength constant, and the Kerr coefficient, or to a greater value.

### (Supplementary Note 9)

A control method including having a control device that controls a quantum annealing device using Kerr nonlinear parametric oscillators control the quantum annealing device to perform quantum annealing so as to, after starting to decrease a detuning value while keeping a pump intensity at 0, increase the pump intensity from 0.

### (Supplementary Note 10)

A program for causing a computer that controls a quantum annealing device using Kerr nonlinear parametric oscillators
to set the value of a pump constant, which is a constant related to the initial value of a pump intensity, of the quantum annealing device to a value determined based on the maximum number of interacting Kerr nonlinear parametric oscillators, an interaction intensity constant, which is a constant indicating the strength of the interaction of the Kerr nonlinear parametric oscillators, and a Kerr coefficient, which is a constant indicating Kerr nonlinearity, or to a greater value; and
to control the quantum annealing device based on the settings to cause quantum annealing to be performed.

### (Supplementary Note 11)

A program for causing a computer that controls a quantum annealing device using Kerr nonlinear parametric oscillators

to control the quantum annealing device to perform quantum annealing so as to, after starting to decrease a detuning value while keeping a pump intensity at 0, increase the pump intensity from 0.

What is claimed is:

1. A control device comprising:
at least one memory configured to store instructions; and
at least one processor configured to execute the instructions to
control a quantum annealing device including Kerr nonlinear parametric oscillators to perform quantum annealing, on the basis of: an interaction number constant, which is a constant indicating the number of interacting Kerr nonlinear parametric oscillators and is set to three or a greater number; an interaction strength constant, which is a constant indicating the strength of interaction of the Kerr nonlinear parametric oscillators; a Kerr coefficient, which is a constant indicating the Kerr nonlinearity of the Kerr nonlinear parametric oscillators; and a pump constant, which is a constant related to the initial value of the pump intensity of the Kerr nonlinear parametric oscillators, which is set to a value determined by the interaction number constant, the interaction strength constant, and the Kerr coefficient, or to a greater value.

2. The control device according to claim 1, wherein the value of the pump constant is set to the value of
$$\frac{p - 4}{2 ( p - 2 )} {( \frac{{K}^{\frac{p - 2}{2}}}{{2}^{p} {( p - 2 )}^{J}} )}^{\frac{2}{p - 4}}$$
or a value greater than that based on the interaction number constant p, the Kerr coefficient K, and the interaction strength constant J.

3. The control device according to claim 1, wherein the value of the pump constant is set to the value of
$$\frac{1}{8} ( \frac{K}{{J}^{\frac{2}{p - 4}}} )$$
or a value greater than that based on the Kerr coefficient K, the interaction strength constant J, and the maximum value p of the number of interacting Kerr nonlinear parametric oscillators.

4. The control device according to claim 1, wherein the at least one processor is configured to execute the instructions to, after starting to decrease a detuning value while keeping a pump intensity at 0, increase the pump intensity from 0.

5. A quantum annealing system comprising a quantum annealing device using Kerr nonlinear parametric oscillators and a control device, wherein the control device comprises:
at least one memory configured to store instructions; and
at least one processor configured to execute the instructions to
control the quantum annealing device to perform quantum annealing, on the basis of: an interaction number constant, which is a constant indicating the number of interacting Kerr nonlinear parametric oscillators and is set to three or a greater number; an interaction strength constant, which is a constant indicating the strength of interaction of the Kerr nonlinear parametric oscillators; a Kerr coefficient, which is a constant indicating the Kerr nonlinearity of the Kerr nonlinear parametric oscillators; and a pump constant, which is a constant related to the initial value of the pump intensity of the Kerr nonlinear parametric oscillators, which is set to a value determined by the interaction number constant, the interaction strength constant, and the Kerr coefficient, or to a greater value.

6. The quantum annealing system according to claim 5, wherein the at least one processor is configured to execute the instructions to, after starting to decrease a detuning value while keeping a pump intensity at 0, increase the pump intensity from 0.

7. A control method comprises making a control device that controls a quantum annealing device using Kerr nonlinear parametric oscillators
control the quantum annealing device to perform quantum annealing, on the basis of an interaction number constant, which is a constant indicating the number of interacting Kerr nonlinear parametric oscillators and is set to three or a greater number; an interaction strength constant, which is a constant indicating the strength of interaction of the Kerr nonlinear parametric oscillators; a Kerr coefficient, which is a constant indicating the Kerr nonlinearity of the Kerr nonlinear parametric oscillators; and a pump constant, which is a constant related to the initial value of the pump intensity of the Kerr nonlinear parametric oscillators, which is set to a value determined by the interaction number constant, the interaction strength constant, and the Kerr coefficient, or to a greater value.

8. The method according to claim 7 further comprising, after starting to decrease a detuning value while keeping a pump intensity at 0, increasing the pump intensity from 0.
